(19) United States
(12) Patent Application Publication
(10) Pub. No.: US 2010/0131187 A1
(43) Pub. Date: May 27, 2010

(54) POI RECOMMENDATION APPARATUS AND METHODS, AND STORAGE MEDIA

(75) Inventors: Wei-Shen Lai, Taipei County (TW); Chia-Chun Shih, Taipei County (TW); Chang-Tai Hsieh, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INSTITUTE FOR INFORMATION INDUSTRY, Taipei (TW)

(21) Appl. No.: 12/334,577

(22) Filed: Dec. 15, 2008

(30) Foreign Application Priority Data
Nov. 24, 2008 (TW) 97145319

(51) Int. Cl. G01C 21/00; G06F 17/30; G06F 7/06

(52) U.S. Cl. 701/200; 707/E17.108

(57) ABSTRACT

The invention discloses a POI recommendation apparatus comprising a database and a POI recommendation module. The database provides a plurality of predetermined POIs, each having popularity information corresponding to a time period. The POI recommendation module finds out a recommended POI corresponding to the time period from the predetermined POIs according to the popularity information, and transmits the recommended POI to an electronic device.

### BACKGROUND OF THE INVENTION

1. Field of the Invention

The invention relates generally to a Place of Interest (POI) recommendation apparatus and method, and more particularly, to a POI recommendation apparatus and method that recommends POIs based on the popularity of POI information and a time period.

2. Description of the Related Art

Currently, there are a variety of navigation systems available, each possessing an electronic map along with plenty of built-in Places of Interest (POIs) (referred to as predetermined POIs hereinafter) for providing users navigation services. However, there are always some little-known POIs (referred to as non-predetermined POIs hereinafter) that are not contained in the navigation systems, thus, preventing related navigation services from being provided. Furthermore, none of the conventional navigation systems are able to provide navigation services based on the popularity of POI information and a time period. This, in some way, somewhat makes the modern navigators incomplete in terms of functionality.

### BRIEF SUMMARY OF THE INVENTION

In light of the previously described problems, the objective of the invention is to provide a POI recommendation apparatus and method that is capable of providing navigation services for little-known POIs. Also, the POI recommendation apparatus and method are able to provide navigation services based on the popularity of POI information and a time period.

The invention discloses a POI recommendation method comprising providing a plurality of predetermined POIs, each having popularity information corresponding to a time period. The method further comprises finding out a recommended POI corresponding to the time period from the predetermined POIs according to the popularity information, and transmitting the recommended POI to an electronic device.

Furthermore, the invention discloses a POI recommendation apparatus comprising a database and a POI recommendation module. The database provides a plurality of predetermined POIs, each having popularity information corresponding to a time period. The POI recommendation module finds out a recommended POI corresponding to the time period from the predetermined POIs according to the popularity information, and transmits the recommended POI to an electronic device.

Furthermore, the invention discloses a storage medium for storing a POI recommendation program. The POI recommendation program comprises a plurality of program codes to be loaded onto a computer system so that a POI recommendation method can be executed by the computer system. The POI recommendation method comprises providing a plurality of predetermined POIs, each having popularity information corresponding to a time period. The method further comprises finding out a recommended POI corresponding to the time period from the predetermined POIs according to the popularity information, and transmitting the recommended POI to an electronic device.

### BRIEF DESCRIPTION OF THE DRAWINGS

The invention can be more fully understood by reading the subsequent detailed description and examples with references made to the accompanying drawings, wherein:

FIG. 1 depicts a diagram of an embodiment of a POI recommendation system 100 according to the invention;

FIG. 2 depicts a flowchart of an embodiment of a POI recommendation system 100 according to the invention;

FIG. 3 depicts an example of important word groups;

FIG. 4 depicts an example of popularity for POI “Guan Shan sunset” information;

FIG. 5 depicts an acquisition flowchart of predetermined POIs according to the invention;

FIG. 6 depicts an acquisition flowchart of non-predetermined POIs according to the invention; and

FIG. 7 depicts a result with a TF-IDF mechanism applied to the word groups seen in FIG. 3.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

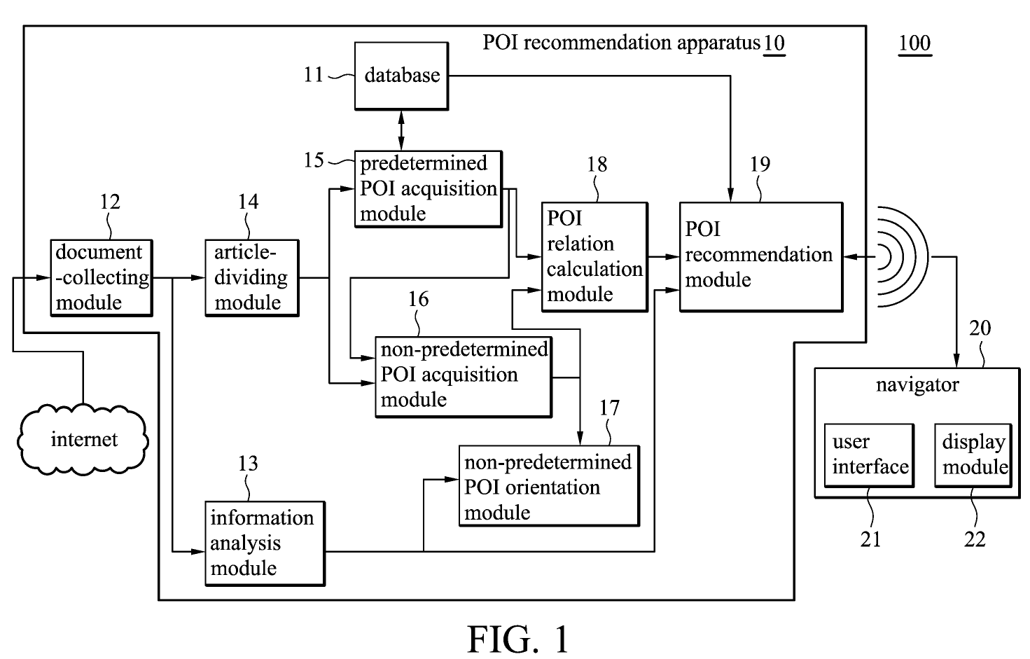

FIG. 1 depicts a diagram of an embodiment of a POI recommendation system 100 according to the invention. The POI recommendation system 100 comprises a POI recommendation apparatus 10 and a navigator 20. The POI recommendation apparatus 10 comprises a database 11, a document-collecting module 12, an information analysis module 13, an article-dividing module 14, a predetermined POI acquisition module 15, a non-predetermined POI acquisition module 16, a non-predetermined POI orientation module 17, a POI relation calculation module 18 and a POI recommendation module 19. The navigator 20 comprises a user interface 21 and a display module 22. The POI recommendation apparatus 10 may be a remote satellite device. In this regard, the satellite device communicates with the navigator 20 in a wireless manner. Furthermore, the database 11 in the satellite device pre-stores an electronic map along with a plurality of built-in POIs to provide navigation services.

The operation of the components for a POI recommendation system 100 will be described in detail below.

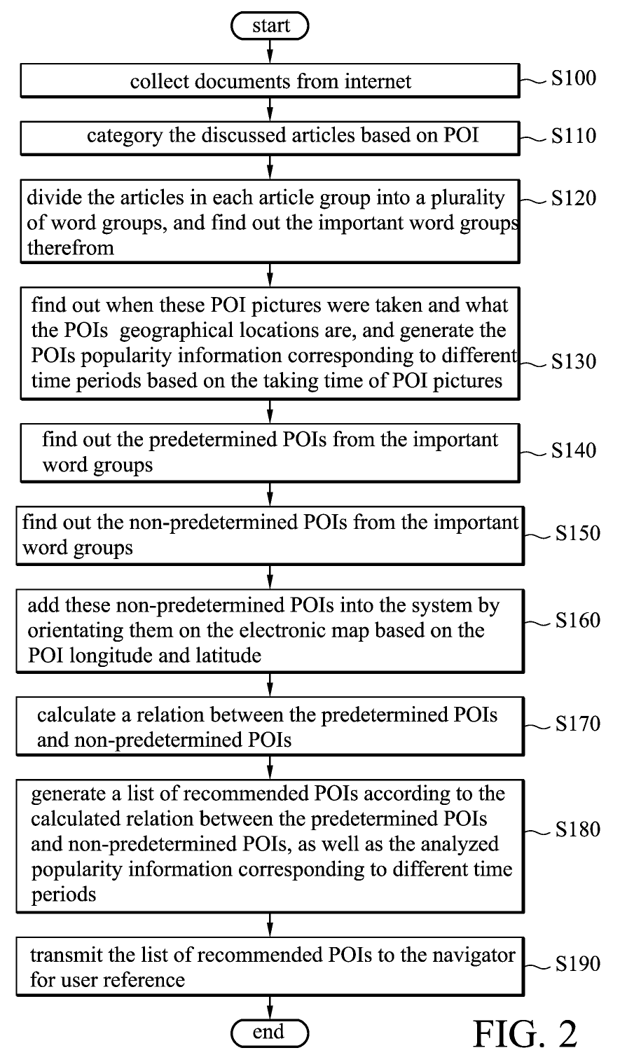

FIG. 2 depicts a flowchart of an embodiment of a POI recommendation system 100 according to the invention. The document-collecting module 12 is connected to internet to collect documents (S100), and the collected documents are preferably abundant and cover a wide range of tourist POIs. The sources of collected documents may be on-line blogs (non-limiting), and the collected documents should comprise at least two parts-namely, the discussed POI articles and pictures. The discussed POI articles are sent to the article-dividing module 14 for subsequent dividing procedures, whereas the POI pictures are sent to the information analysis module 13 for analyzing and obtaining the popularity of the POI information (i.e. how popular a POI is). Simultaneously, the POI pictures are sent to the information analysis module 13 to analyze and obtain the geographical location of the POI-namely, the longitude and latitude information of the POI. In the next step, the article-dividing module 14 categorizes the discussed articles based on the POI (S110). For example, the articles related to a POI “Ken Ding” may be categorized in the same article group, whereas those related to a POI “Dan Shuei” may be categorized in another article group.

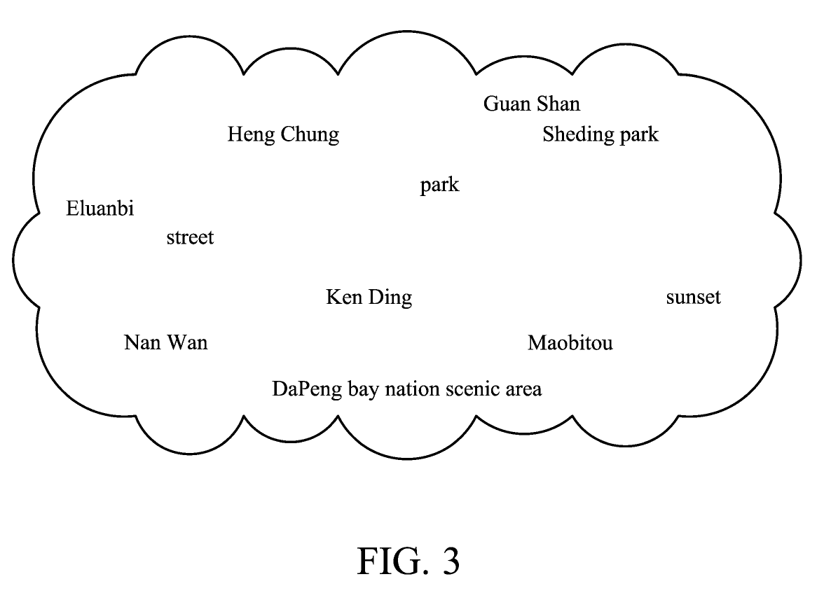

In the next step, the article-dividing module 14 divides every article in each article group into a plurality of word groups, and finds out the important word groups therefrom (S120). For example, all articles in the same article group “Ken Ding” are divided into a plurality of word groups, and it is determined which word groups often appear in these articles. If a word group often appears in these articles, then it is considered important. In this manner, important word groups can be obtained. FIG. 3 depicts an example of important word groups, such as “Ken Ding”, “Eluanbi” and “sunset”.

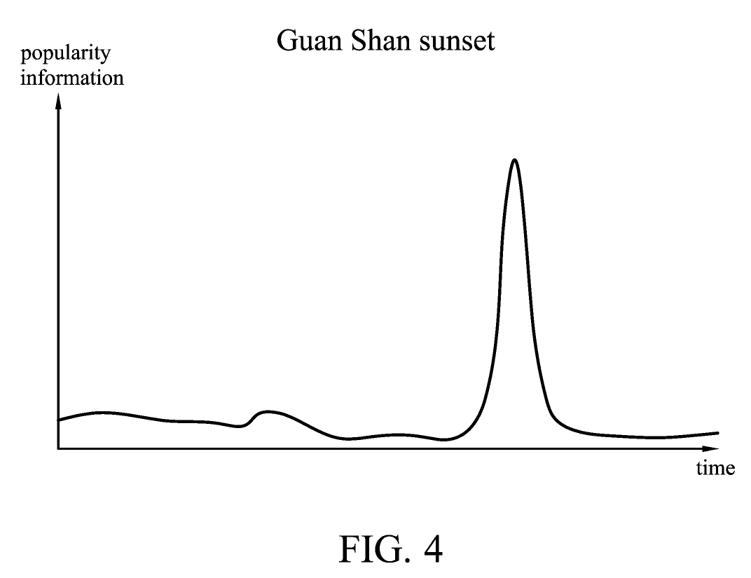

In the next step, the information analysis module 13 analyzes the received POI pictures in order to find out when the POI pictures were taken and the geographical location of the POI (S130). Still further, the information analysis module 13 generates the popularity of POI information corresponding to different time periods (or seasons) based on the time the POI pictures were taken (S130). For example, for a group of pictures from a POI “Nan Wan beach”, if it is analyzed that most of the pictures were photographed between 14:00 to 17:00 o'clock, then it is determined that the POI “Nan Wan beach” is most visited (most tourists) during this time period. Therefore, the popularity of the POI information corresponding to the time period pm 14:00 to 17:00 is determined highest for the POI “Nan Wan beach”. On the contrary, if very few pictures are taken between 22:00 to 24:00 o'clock, then it is determined that the POI “Nan Wan beach” is least visited (least tourists) during this time period. Therefore, the popularity of the POI information corresponding to the time period 22:00 to 24:00 o'clock is determined lowest for the POI “Nan Wan beach”. In this manner, the popularity of the POI information corresponding to different time periods for each POI can be obtained, and further sent to the POI recommendation module 19 for subsequent processing. FIG. 4 depicts an example of popularity for POI “Guan Shan sunset” information.

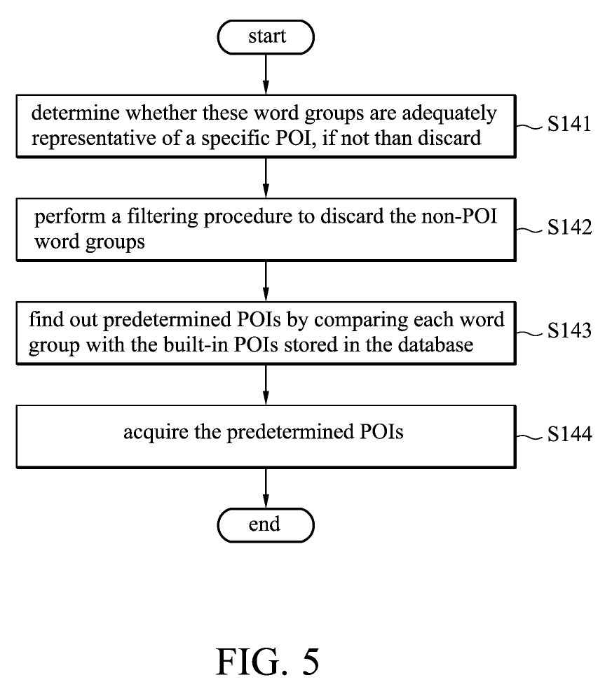

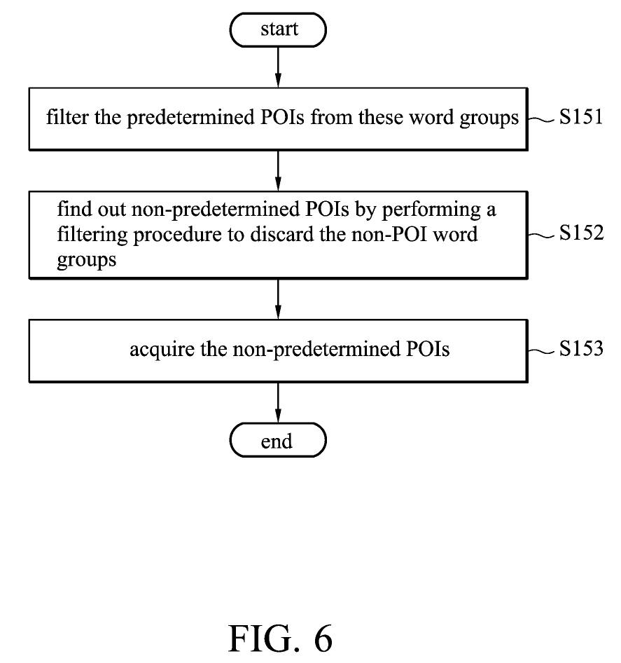

In the next step, the predetermined POI acquisition module 15 finds out the predetermined POIs from the important word groups obtained in step S120 (S140). Following, the detailed finding out process will be described with reference to FIG. 5. It is noted that each important word group obtained in step S120 is compared with the built-in POIs stored in the database 11. For the important word groups that are already available in the database 11, they are defined as predetermined POIs, in principle. Next, the non-predetermined POI acquisition module 16 finds out the non-predetermined POIs also from the important word groups obtained in step S120 (S150). Following, the detailed finding out process will also be described with reference to FIG. 6. It is noted that each important word group obtained in step S120 is compared with the built-in POIs stored in the database 11. For the important word groups that are not yet available in the database 11, they are defined as non-predetermined POIs, in principle. Next, the non-predetermined POI orientation module 17 may add the non-predetermined POIs into the system by orientating them on the electronic map based on the POI longitude and latitude obtained in step S130 (S160), thereby adding the navigation service of non-predetermined POIs.

After the predetermined POIs and non-predetermined POIs are found, the POI relation calculation module 18 calculates a relation between the predetermined POIs and non-predetermined POIs (S170), and the calculated relation result is further output to the POI recommendation module 19. The detailed calculating process will be described below.

Along with calculating the relation between the predetermined POIs and non-predetermined POIs, as well as analyzing popularity of POI information corresponding to different time periods, the POI recommendation module 19 may also generate a list of recommended POIs based on a user-queried POI and time period (S180). Further, the list of recommended POIs is transmitted to the navigator 20 so as to be displayed on the display module 22 for user reference (S190). For example, when a user, through the user interface 21, queries a POI “Ken Ding” in time period “afternoon”, then the POI recommendation module 19, according to the calculated relation, may generate a recommended list comprising POIs such as “Ken Ding museum of biology & aquarium” and “Nan Wan beach” that have stronger relation with the queried POI “Ken Ding” and are also more suitable to be visited in the afternoon. Then, the recommended list is transmitted to the navigator 20 and displayed on the display module 22 for user reference. Similarly, if the user queries a POI “Ken Ding” in the time period “night time”, the POI recommendation module 19 may recommend a POI such as “night market”, which has a strong relation with “Ken Ding” and is also suitable to be visited during the night.

Above is the completed flowchart of the POI recommendation system 100 according to the invention. Next, the finding process of predetermined POIs and non-predetermined POIs, as well as the calculating process of POI relationships will be described below.

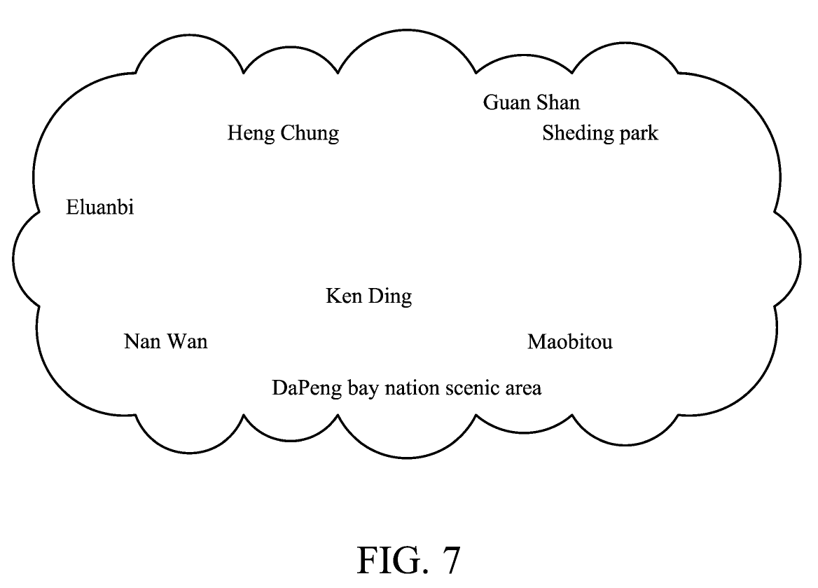

FIG. 5 depicts an acquisition flowchart of predetermined POIs according to the invention. With the important word groups obtained in step S120, the predetermined POI acquisition module 15 determines whether these word groups are adequately representative of the POI “Ken Ding” (S141). If a word group is not adequately representative of the POI “Ken Ding”, then it will be discarded (S141). Only those adequately representative of the POI “Ken Ding” will be kept. The determination mechanism utilized may be a TF-IDF (Term Frequency-Inverse Document Frequency) mechanism. For example, the word group “Heng Chung” in FIG. 3 is representative of the POI “Ken Ding” as it is a unique resort nearby “Ken Ding”. As for the word group “sunset”, it is not representative of the POI “Ken Ding” as it is something that exists not only in “Ken Ding” but everywhere. Therefore, the word group “sunset” will be discarded. The result of the TF-IDF mechanism applied to the word groups shown in FIG. 3, is shown in FIG. 7. After the processing of the TF-IDF mechanism, the word groups “street”, “sunset” and “park” seen in FIG. 3 are discarded. In the next step, with the word groups obtained in step S141, the predetermined POI acquisition module 15 performs a filtering procedure in order to further discard the non-POI word groups (S142), such as the activity name (“surfing” or “scuba diving”), food name (“steamed dumpling” or “mango ice”) or local specialty (sun-cake). With the word groups obtained in step S142, the predetermined POI acquisition module 15 compares each word group with the built-in POIs stored in the database 11 (S143). If a word group is found in the database 11, then the word group is referred to as a predetermined POI. Finally, the predetermined POI acquisition module 15 acquires the predetermined POIs (S144).

It is noted that step S142 is not a compulsory procedure. If it is skipped, then the acquired predetermined POIs may comprise of activity name, food name or local specialty. Consequently, in the step S170, a relation between the activity name, food name or local specialty and the predetermined/non-predetermined POIs is calculated. In the followings, the POI recommendation module 19 recommends to the user a list of predetermined/non-predetermined POIs based on a user-queried activity name, food name or local specialty. For example, when a user, through the user interface 21, queries an activity name “surfing”, then the POI recommendation module 19, according to the popularity information and time period, may generate a list of recommended POIs, such as “Ken Ding”, “WuShih harbor” or “Honeymoon Bay”. Additionally, the POI recommendation module 19 is not only able to generate a list of recommended POIs based on the user's current location (current POI), but also able to show users what is special about the recommended POIs, such as special delicacies “steamed dumpling”, “mango ice” etc. Therefore, users will be able to know what special foods or local specialties are available around their area, and be able to get there with the guidance of the navigator 20.

FIG. 6 depicts an acquisition flowchart of non-predetermined POIs according to the invention. With the important word groups obtained in step S120, the non-predetermined POI acquisition module 16 filters the predetermined POIs from the word groups (S151). Next, similar to step S142, the non-predetermined POI acquisition module 16 performs a filtering procedure in order to further discard the non-POI word groups (S152). The remaining word groups after step S152 are considered as non-predetermined POIs. Finally, the non-predetermined POI acquisition module 16 acquires the non-predetermined POIs (S153).

In step S170, the POI relation calculation module 18 calculates the relation between the predetermined POIs and non-predetermined POIs. The following is the detailed calculating process.

With the article group “Ken Ding” as an example, in the step S100, assume that there are 9 articles Art 001 to Art 009 received from the internet, as shown in Table 1 below:

TABLE 1
Representative POIs for Articles

| Article ID | Representative POIs |
|---|---|
| Art 001 | Ken Ding, museum of biology & aquarium, Guan Shan |
| Art 002 | museum of biology & aquarium, Maobitou |
| Art 003 | museum of biology & aquarium, Chuanfanshih |
| Art 004 | Ken Ding, museum of biology & aquarium, Maobitou |
| Art 005 | Ken Ding, Chuanfanshih |
| Art 006 | museum of biology & aquarium, Chuanfanshih |
| Art 007 | Ken Ding, Chuanfanshih |
| Art 008 | Ken Ding, museum of biology & aquarium, |
| | Chuanfanshih, Guan Shan |
| Art 009 | Ken Ding, Chuanfanshih, Guan Shan |

Wherein, the POIs shown in Table 1 comprise predetermined POIs and non-predetermined POIs. In addition, the “Ken Ding, museum of biology & aquarium, Guan Shan” corresponding to Art 001 are the representative POIs for Art 001, and so are the others. Next, for each POI, the amount of articles that each POI appears in is calculated and shown in Table 2 below:

TABLE 2
Amount of Articles Each POI Appears In

| | Amount of Articles Each |
|---|---|
| POI | POI Appears In |
| Ken Ding | 6 |
| museum of biology & aquarium | 7 |
| Chuanfanshih | 6 |
| Maobitou | 2 |
| Guan Shan | 2 |

Table 2 shows that the POI “Ken Ding” appears in 6 articles, for example. In this regard, the POI “Ken Ding” has an appearance frequency of 6.

Next, the POIs with appearance frequency lower than a predetermined value will be eliminated from the Table 2. In this embodiment, the predetermined value is defined as 2. Table 3 shows the result after elimination:

TABLE 3
Amount of Articles Each POI Appears In After Elimination

| | Amount of Articles Each POI |
|---|---|
| POI | Appears In After Elimination |
| Ken Ding | 6 |
| museum of biology & aquarium | 7 |
| Chuanfanshih | 6 |
| Maobitou | 2 |
| Guan Shan | 2 |

As shown Table 3 is the same as Table 2, since there is no POI with an appearance frequency lower than 2. Next, each POI in Table 3 is paired with the other POIs so as to form pairs of POIs, and the amount of articles in which each POI pair appears in is calculated again, as shown in Table 4 below:

TABLE 4
Amount of Articles Each POI Pair Appears In

| | Amount of Articles Each |
|---|---|
| POI pair | POI Pair Appears In |
| Ken Ding, museum of biology & aquarium | 3 |
| Ken Ding, Chuanfanshih | 4 |
| Ken Ding, Maobitou | 1 |
| Ken Ding, Guan Shan | 2 |
| museum of biology & aquarium, Chuanfanshih | 4 |
| museum of biology & aquarium, Maobitou | 2 |
| museum of biology & aquarium, Guan Shan | 2 |
| Chuanfanshih, Maobitou | 0 |
| Chuanfanshih, Guan Shan | 1 |
| Maobitou, Guan Shan | 0 |

Table 4 shows that the POI pair “Ken Ding, museum of biology & aquarium” appears in 3 articles, for example. In this regard, the POI pair “Ken Ding, museum of biology & aquarium” has an appearance frequency of 3. According to the statistics of Table 3 and Table 4, it reveals that the probability of the POI “museum of biology & aquarium” has been raised to 50% ( 3/6, the amount of articles in which the POI pair “Ken Ding, museum of biology & aquarium” appears in/the amount of articles in which the POI “Ken Ding” appears in) when analyzing the POI “Ken Ding”. Therefore, the relation of POI “museum of biology & aquarium” with respect to POI “Ken Ding” is 50%. In conclusion, based on the statistic result of Table 3 and Table 4, the POI relation can be seen as follows:

| | |
|---|---|
| Ken Ding → Chuanfanshih | 4/6 = 66% |
| Ken Ding → museum of biology & aquarium | 3/6 = 50% |
| Ken Ding → Guan Shan | 2/6 = 33% |
| museum of biology & aquarium → Ken Ding | 4/7 = 57% |
| museum of biology & aquarium → Chuanfanshih | 4/7 = 57% |
| museum of biology & aquarium → Maobitou | 2/7 = 29% |
| museum of biology & aquarium → Guan Shan | 2/7 = 29% |
| Chuanfanshih → Ken Ding | 4/6 = 66% |
| Chuanfanshih → museum of biology & aquarium | 4/6 = 66% |
| Guan Shan → Ken Ding | 2/2 = 100% |
| Guan Shan → museum of biology & aquarium | 2/2 = 100% |

According to the above description, when a user queries the POI “Ken Ding”, the POI recommendation module 19 will recommend the user the POIs “Chuanfanshih (66%)”, “museum of biology & aquarium (50%)” and “Guan Shan (33%)” in order. The same is for other POIs.

Next, the POI pairs with appearance frequency lower than the predetermined value will be discarded, as shown in Table 5:

TABLE 5
Amount of Articles Each POI Pair Appears In After Being
Discarded

| | Amount of Articles Each POI Pair |
|---|---|
| POI pair | Appears In After Being Discarded |
| Ken Ding, museum of | 3 |
| biology & aquarium | |
| Ken Ding, Chuanfanshih | 4 |
| Ken Ding, Guan Shan | 2 |
| museum of biology & | 4 |
| aquarium, Chuanfanshih | |
| museum of biology & | 2 |
| aquarium, Maobitou | |
| museum of biology & | 2 |
| aquarium, Guan Shan | |

Next, every three POIs in Table 5 is paired to form a new POI pair again, as shown in Table 6:

TABLE 6
Amount of Articles Each POI Pair Appears In (Second Time)

| | Amount of Articles Each POI |
|---|---|
| POI pair | Pair Appears In (Second Time) |
| Ken Ding, museum of biology & | 2 |
| aquarium, Guan Shan | |
| Ken Ding, museum of biology & | 2 |
| aquarium, Chuanfanshih | |

With each three-POI pair seen in Table 6, any two POIs out of each three-POI pair should be seen in Table 5 as a POI pair.

Finally, the POI pairs with appearance frequency lower than the predetermined value will be discarded again. Table 5 remains unchanged after the discarding procedure. In addition, the above pairing procedure will be repeated until the amount of articles in which each latest POI pair appears in is not higher than the predetermined value (In this embodiment, the paring procedure ends as shown in Table 6 as the appearance frequency for each POI pair appears to have converged).

In addition, the POI recommendation method can be recorded as a program in a storage medium for performing the above procedures, such as an optical disk, floppy disk and portable hard drive and so on. It is to be emphasized that the program of the POI recommendation method is formed by a plurality of program codes corresponding to the procedures described above.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A POI recommendation method, comprising:
providing a plurality of predetermined POIs, each having popularity information corresponding to a time period;
finding out a recommended POI corresponding to the time period from the predetermined POIs according to the popularity information; and
transmitting the recommended POI to an electronic device.

2. The POI recommendation method as claimed in claim 1, wherein the electronic device is a navigator.

3. The POI recommendation method as claimed in claim 1, wherein the popularity information is determined by the tourist number of the predetermined POIs.

4. The POI recommendation method as claimed in claim 1, further comprising receiving a plurality of documents from the internet.

5. The POI recommendation method as claimed in claim 4, further comprising calculating a relation among the predetermined POIs according to the amount of documents in which the predetermined POIs appear.

6. The POI recommendation method as claimed in claim 4, further comprising calculating a relation between an activity name and the predetermined POIs according to the amount of documents in which the activity name and the predetermined POIs appear.

7. The POI recommendation method as claimed in claim 6, further comprising finding out the recommended POI from the predetermined POIs according to the calculated relation.

8. The POI recommendation method as claimed in claim 4, wherein the predetermined POIs are provided by a database, and the method further comprises providing at least a non-predetermined POI according to the documents.

9. A POI recommendation apparatus, comprising:
a database providing a plurality of predetermined POIs, each having popularity information corresponding to a time period; and
a POI recommendation module finding out a recommended POI corresponding to the time period from the predetermined POIs according to the popularity information, and transmitting the recommended POI to an electronic device.

10. The POI recommendation apparatus as claimed in claim 9, wherein the electronic device is a navigator.

11. The POI recommendation apparatus as claimed in claim 9, further comprising an information analysis module determining the popularity information according to the tourist number of the predetermined POIs.

12. The POI recommendation apparatus as claimed in claim 9, further comprising a document-collecting module receiving a plurality of documents from the internet.

13. The POI recommendation apparatus as claimed in claim 12, further comprising a POI relation calculation module calculating a relation among the predetermined POIs according to the amount of documents in which the predetermined POIs appear.

14. The POI recommendation apparatus as claimed in claim 12, further comprising a POI relation calculation module calculating a relation between an activity name and the predetermined POIs according to the amount of documents in which the activity name and the predetermined POIs appear.

15. The POI recommendation apparatus as claimed in claim 14, wherein the POI recommendation module finds out the recommended POI from the predetermined POIs according to the calculated relation.

16. The POI recommendation apparatus as claimed in claim 12, further comprising a non-predetermined POI acquisition module providing at least a non-predetermined POI according to the documents.

17. A storage medium for storing a POI recommendation program, wherein the POI recommendation program comprises a plurality of program codes to be loaded onto a computer system so that a POI recommendation method is executed by the computer system, and the POI recommendation method comprises:
providing a plurality of predetermined POIs, each having popularity information corresponding to a time period;
finding out a recommended POI corresponding to the time period from the predetermined POIs according to the popularity information; and
transmitting the recommended POI to an electronic device.

18. The storage medium as claimed in claim 17, wherein the electronic device is a navigator.

19. The storage medium as claimed in claim 17, wherein the popularity information is determined by the tourist number of the predetermined POIs.

20. The storage medium as claimed in claim 17, wherein the POI recommendation method further comprises:
receiving a plurality of documents from the internet; and
calculating a relation among the predetermined POIs according to the amount of documents in which the predetermined POIs appear.
